(19) United States
(12) Patent Application Publication
(10) Pub. No.: US 2004/0047049 A1
(43) Pub. Date: Mar. 11, 2004

(54) Objective light-converging means and optical pickup device equipped therewith

(75) Inventors: Kohei Ota, Tokyo (JP); Mitsuru Mimori, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 10/654,918

(22) Filed: Sep. 5, 2003

(30) Foreign Application Priority Data
Sep. 10, 2002 (JP) JP2002-264459

(51) Int. Cl. G02B 3/02; G02B 13/18

(52) U.S. Cl. 359/719

(57) ABSTRACT

An objective light converging element for use in an optical pickup device and used to converge a light flux having a reference wavelength λ (380 nm≦λ₀≦450 nm) emitted from a light source onto an information recording plane of an optical information recording medium equipped with a protective substrate having a thickness of 0.6 mm, has a lens structural section to refract a light flux emitted from the light source; and a ring-shaped diffractive structural section having an optical axis on a center and to diffract a light flux emitted from the light source. An order K of a diffracted-light ray having the maximum diffraction efficiency among diffracted-light rays of the light flux generated by the diffractive structural section satisfies the following formula:

3≦K≦14 (provided that K is an integer)

### BACKGROUND OF THE INVENTION

The present invention relates to an objective light-converging means that converges a light flux on an information recording surface of an optical recording medium and to an optical pickup device that is equipped with the objective light-converging means and conducts either one or both of recording and reproducing of information on an information recording surface of the optical recording medium.

Heretofore, with practical use of a red semiconductor laser with a short wavelength, a DVD (Digital Video Disc) representing a high density optical information recording medium (which is also called “optical disc”) that is in a size similar to that of a CD (Compact Disc) and has a large capacity has been commercialized. In addition, a trend toward the short wavelength for the semiconductor laser has been advanced, and an advanced high density optical information recording medium employing a short wavelength blue (purple) laser whose oscillation wavelength is further shorter is about to be put to practical use.

For the trend that a semiconductor laser with a wavelength of about 650 nm is used for a recording and reproducing apparatus for DVD, there is suggested the structure wherein a semiconductor laser of about 405 nm is used, a thickness of a protective base board is made to be 0.6 mm identical to that of DVD, and an objective lens having image-side numerical aperture NA of 0.65 identical to that of DVD is used, for a recording and reproducing apparatus of a HD-DVD type representing one mode of the advanced high density optical information recording medium.

An optical pickup device that conducts reproducing or recording information on an optical pickup device makes a light flux emitted from a laser light source to enter an objective lens, then, makes the light flux that has emerged from the objective lens to be converged on an information recording surface of the optical information recording medium, and thereby, conducts recording of information on the optical information recording medium or reproducing of recorded information. High density of information recorded in the optical information recording medium has been achieved by making a light-converged spot on an information recording surface of the optical information recording medium to be small, by making a wavelength of a laser beam to be short and by making the image-side numerical aperture of the objective lens to be great, as in the advanced high density optical information recording medium.

There has been though out the structure to provide a diffractive ring-shaped structure portion on an optical functional surface of the objective lens for realizing a mode hop correction function for reducing focus shift caused by wavelength change (mode hop) in incident light of the objective lens resulting from temperature change of a laser light source or from optical output change, and a temperature correction function that reduces spherical aberration resulting from refractive index change caused by temperature change in the objective lens. The diffractive ring-shaped structure portion is a structure that can diffract a light flux emitted from the light source by providing plural ring-shaped thin diffractive grooves on the objective lens.

However, since a light flux with a short wavelength is used for reproducing or recording of information for the advanced high density optical information recording medium, a color dispersion characteristic representing a change of refractive index for the wavelength change depending on a type of a material is also increased. Due to this increase of the color dispersion characteristic, paraxial chromatic aberration representing focus shift in the direction of an optical axis in accordance with wavelength changes also grows greater. For the reduction of this paraxial chromatic aberration, diffraction power of the diffractive ring-shaped structure portion is required to grow greater, and for that purpose, the number of diffractive ring-shaped zones needs to be increased (intervals (pitches) of the diffractive ring-shaped zones are made small). Correction of paraxial chromatic aberration is included in the mode hop correction.

With respect to manufacturing of an objective lens on which the diffractive ring-shaped structure portion is provided, a molding die for forming a molded lens has been machined by a cutting tool first so that grooves for transferring the diffractive ring-shaped structure portion may be formed on the molding die, and then, resin materials for an objective lens have been poured into the machined molding die for injection molding.

Further, second order or third order diffracted light has been converged by a light-converging lens (objective lens) in some optical pickup devices each converging a beam with a wavelength of 400-410 nm emitted from a light source on an information recording surface of a recording medium (for example, see Patent Document 1).

(Patent Document 1)

TOKKAI No. 2001-93179 (description of Structure 8 cited from Item 5, description on page 5) (Problems to be solved by the invention)

Though it is possible theoretically to make a pitch of a diffractive ring-shaped structure portion to be extremely small, it is exceedingly difficult to make a molding die for an objective lens. Since the sharpness of a cutting tool for machining the molding die is limited, a precision of machining the molding die is also limited. In addition, transferability for molding an objective lens from the molding die is also limited. Because of these two factors, therefore, dullness (roundness) is formed on an edge portion of the diffractive ring-shaped structure portion, when conducting injection molding for the objective lens having a microscopic diffractive ring-shaped structure portion. Further, even when forming the diffractive ring-shaped structure portion by machining the objective lens itself with a cutting tool, dullness is formed on the edge portion of the diffractive ring-shaped structure portion equally, because sharpness of a cutting tool and a precision of processing are limited.

FIG. 5 is a sectional view of diffractive ring-shaped structure portion α of an objective lens. With regard to serrated diffractive ring-shaped structure portion α on the objective lens, dullness α21 is formed by molding of an objective lens on the edge portion on actual molded surface α2, compared with designed ideal molded surface α1, as is shown in FIG. 5.

On the dullness α21 on the edge of the diffractive ring-shaped structure portion α, diffraction efficiency is lowered in the course of emission of diffracted light on an information recording surface of an optical information recording medium, and an amount of effective diffracted light is lost. Since the wavelength of incident light is specified to be short for the advanced high density optical information recording medium, the number of ring-shaped zones needs to be increased for enhancing diffraction power as stated above, and a pitch needs to be small compared with an occasion of the structure to use incident light with a long wavelength in the same order, when correcting paraxial chromatic aberration. When pitch P of the diffractive ring-shaped structure portion α shown in FIG. 5 is small, the number of ring-shaped zones is increased, then, the number of cases of dullness on the edge is increased, diffraction efficiency is further lowered, an amount of effective diffracted light is lost, and an amount of sufficient diffracted light cannot be obtained, which are the problems. In particular, in the case of the structure to emit diffracted light in low order such as primary and secondary for incident light with a short wavelength, the diffractive ring-shaped structure portion turns out to be extremely microscopic.

For solving these problems, there may be provided a ring-shaped zone structure that converges a high order diffracted light on an optical information recording medium. In the diffractive ring-shaped structure portion that makes a diffracted light in high order to emerge, it is possible to make the pitch P to be large and to reduce the number of ring-shaped zones, and thereby, the number of cases of dullness on the edge portion in diffractive ring-shaped structure portion α, diffraction efficiency is raised, and an amount of sufficient diffracted light can be obtained.

However, in the structure to employ diffracted light in high order, on the other hand, when there is a change of a wavelength of incident light emitted from a laser light source, diffraction efficiency in high order is also lowered depending on the extent of the change in wavelength, and there is a fear that a sufficient amount of diffracted light cannot be obtained, which has been a problem.

In Patent Document 1, there is no description about converging the diffracted light in high order of fourth order or higher, although there is description about converging a light beam with a wavelength of 400-410 nm on an information recording surface of a recording medium, and dullness on the diffractive ring-shaped structure portion or an influence of a change in a wavelength of a laser light source on an amount of emitted light of diffracted light is not taken into consideration at all.

### SUMMARY OF THE INVENTION

An object of the invention is to conduct mode hop correction, and to converge diffracted light in a sufficient amount on an information recording surface of an optical information recording medium by enhancing diffraction efficiency, even when dullness is caused on a diffractive structure portion of an objective lens and a wavelength change is caused on a light flux having a short wavelength emitted from a light source.

Item (1)

To solve the problem stated above, the invention described in Item (1) is represented by an objective light-converging means of an optical pickup device used for converging a light flux with standard wavelength λ₀ (380 nm≦λ₀≦450 nm) emitted from a light source on an information recording surface of an optical information recording medium with a protective base board whose thickness is 0.6 mm, wherein there are provided a lens structure portion that refracts a light flux emitted from the light source and a diffractive structure portion in a form of ring-shaped zones on the optical axis as a center that diffracts a light flux emitted from the light source, and diffraction order K of the diffracted light whose diffraction efficiency is greatest among diffracted light obtained by diffracting light fluxes emitted from the light source with the diffractive structure portion satisfies 3≦K≦14 (K is an integer).

In the invention described in Item (1), diffraction order K of the greatest diffraction efficiency in the diffractive structure portion is in the range of 3≦K≦14, and therefore, the objective light-converging means can enhance the diffraction efficiency of K order diffracted light and can converge a light flux with a sufficient amount of light on an information recording surface of an optical information recording medium, while having the functions to correct paraxial chromatic aberration and to correct focus shift caused by mode hop, even in the case where dullness is formed on the diffractive structure portion and shifting of actually used wavelength λ from short standard wavelength λ₀ is caused.

Item (2)

The objective light-converging means according to the Item (1) wherein a material of each of the lens structure portion and the diffractive structure portion is plastic.

In the invention described in Item (2), it is possible to realize easy molding, low cost and light weight of the objective light-converging means because a material of each of the lens structure portion and the diffractive structure portion is plastic.

Item (3)

The objective light-converging means according to the Item (1) or (2) wherein each of the lens structure portion and the diffractive structure portion is composed of a single lens or a plurality of optical elements.

In the invention described in Item (3), it is possible to employ various structures because each of the lens structure portion and the diffractive structure portion is composed of a single lens or a plurality of optical elements. In particular, when the structure portion is composed of a plurality of optical elements, it is possible to employ the structure wherein the diffractive structure portion is provided on each optical element.

Item (4)

The objective light-converging means according to either one of the Items (1)-(3) wherein numerical aperture NA of the objective light-converging means on the side of the optical information recording medium satisfies 0.60≦NA≦0.90.

In the invention described in Item (4), it is possible to prevent a decline of recording density of the optical information recording medium caused by the small numerical aperture NA and to prevent that manufacture of the objective light-converging means is difficult because numerical aperture NA is great, because numerical aperture NA of the objective light-converging means on the side of the optical information recording medium satisfies 0.60≦NA≦0.90.

Item (5)

The objective light-converging means according to Item (4) wherein numerical aperture NA of the objective light-converging means on the side of the optical information recording medium satisfies 0.60≦NA≦0.70.

In the invention described in Item (5), it is possible to prevent a decline of recording density of the optical information recording medium caused by the small numerical aperture NA and to prevent further that manufacture of the objective light-converging means is difficult because numerical aperture NA is great, because numerical aperture NA of the objective light-converging means on the side of the optical information recording medium satisfies 0.60≦NA≦0.70.

Item (6)

The objective light-converging means according to either one of the Items (1)-(5) wherein focal distance f from a principal point of the objective light-converging means to a focal point on the optical information recording medium satisfies 1.8 mm≦f≦3.0 mm.

In the invention described in Item (6), focal distance f from a principal point of the objective light-converging means to a focal point on the optical information recording medium satisfies 1.8 mm≦f≦3.0 mm, and therefore, it is possible to prevent that a working distance is reduced by small focal distance f, and the objective light-converging means is damaged and contaminated accordingly, and it is possible to prevent that a size of an optical pickup device equipped with the objective light-converging means is made to be large because focal distance f is large. The working distance is a distance from, for example, a mounting portion for an emergent surface toward an optical information recording medium of the objective light-converging means or for the objective light-converging means to an image recording surface of the optical information recording medium. When the working distance is small, the objective light-converging means tends to be touched from the outside, and thereby, a possibility for the objective light-converging means to be damaged or contaminated becomes high.

Item (7)

The invention described in Item (7) is an optical pickup device having therein a light source and an objective light-converging means described in either one of Items 1-6, wherein a light flux emitted from the light source enters the objective light-converging means and a light flux which has emerged from the objective light-converging means is converged on an information recording surface of the optical information recording medium so that either one of recording and reproducing of information or both of them are conducted.

In the invention described in Item (7), it is possible to enhance the diffraction efficiency of K-order diffracted light and to converge a light flux with a sufficient amount of light on an information recording surface of an optical information recording medium so that either one of reproducing and recording of information or both of them may be conducted, while keeping the function to correct focus shift caused by mode hop, even when dullness is formed on a diffractive structure portion and deviation of actually used wavelength λ from short standard wavelength λ₀ is caused, because an objective light-converging means in either one of Items 1-6 is used to converge light on an information recording surface of an optical information recording medium. It is further possible to increase the speed of either one or both of reproducing and recording of information for an information recording surface because an amount of light of a light flux to be converged on the information recording surface of the optical information recording medium is enhanced with high diffraction efficiency, and it is possible to reduce the power of the light flux emitted from the light source.

### BRIEF DESCRIPTION OF THE DRAWINGS

FIG. 1 is a diagram showing a schematic structure of optical pickup device 1 equipped with objective lens 16 in the present embodiment of the invention.

FIG. 2 is a diagram showing a structural section of objective lens 16.

FIG. 3 is a diagram showing diffraction efficiency for diffraction order K of diffracted light.

FIG. 4 is a diagram showing relationship between vertical spherical aberration SA and numerical aperture NA.

FIG. 5 is a sectional view of diffractive ring-shaped structure portion α of an objective lens.

### DETAILED DESCRIPTION OF THE PREFERRED EMBODIMENT

An embodiment of the invention will be explained as follows, referring to the drawings attached.

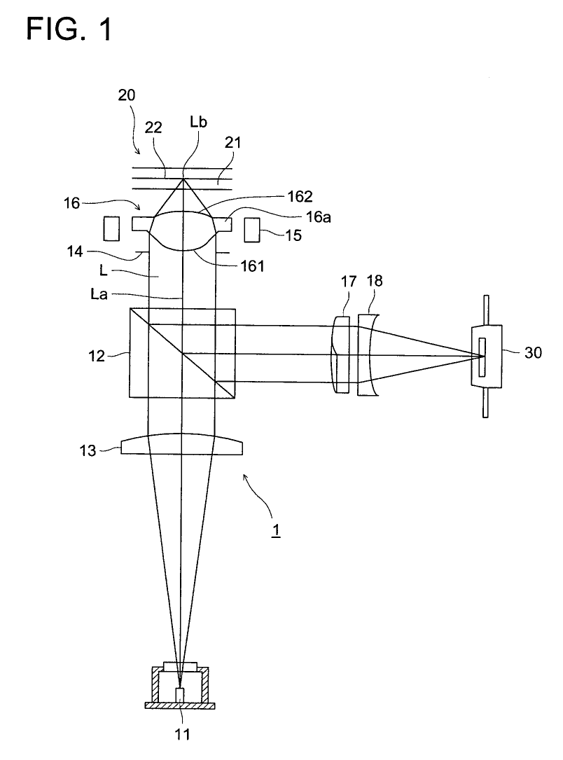

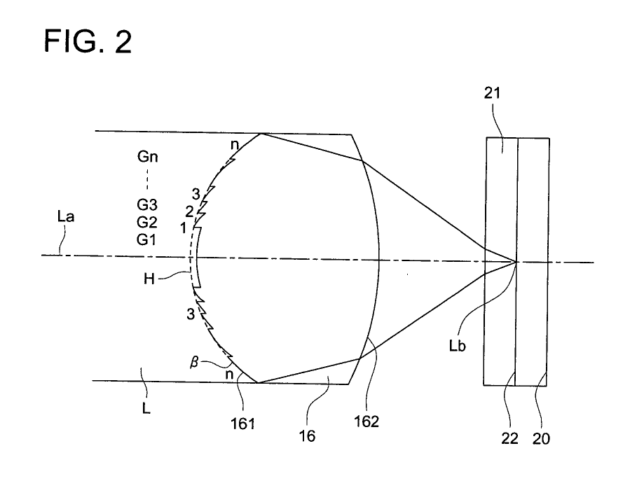

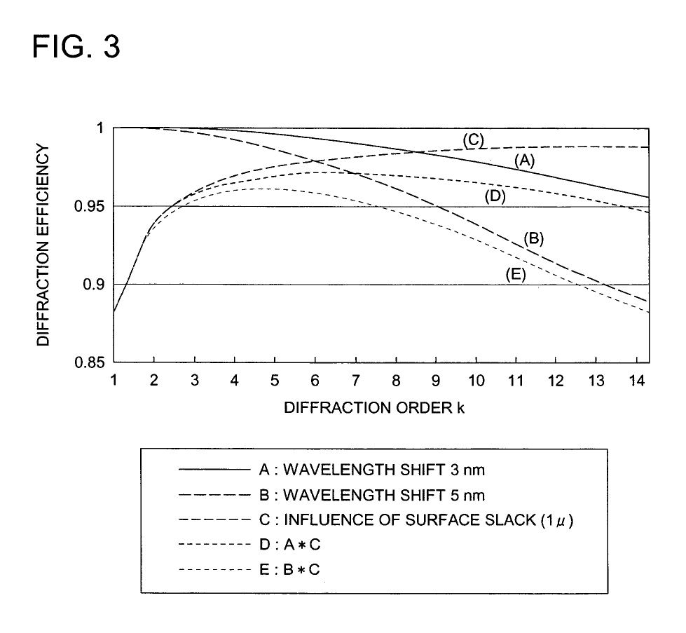

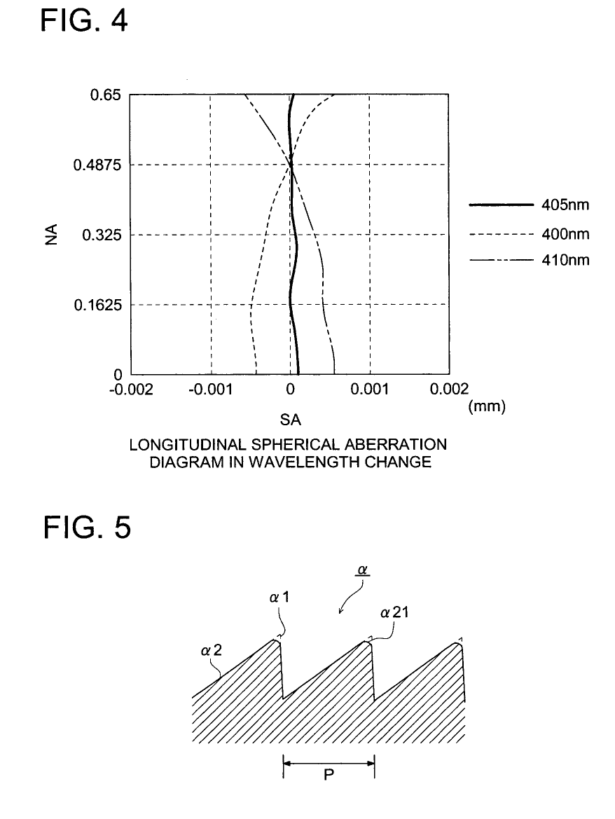

An embodiment of the invention will be explained by referring to FIGS. 1-4. FIG. 1 is a diagram showing a schematic structure of optical pickup device 1 equipped with objective lens 16 in the present embodiment, FIG. 2 is a diagram showing a structural sectional view of the objective lens 16, FIG. 3 is a diagram showing diffraction efficiency for diffraction order K of diffracted light and FIG. 4 is a diagram showing the relationship between longitudinal spherical aberration SA and numerical aperture NA.

Optical pickup device 1 of the present embodiment is structured to read or record information by converging light flux L with standard wavelength for use λ₀ (=405 nm) emitted from semiconductor laser light source 11 (light source) on information recording surface 22 through objective lens 16, concerning HD-DVD 20 that is an example of an optical information recording medium of an advanced high density optical disc.

As shown in FIG. 1, in the optical pickup device 1, there is arranged beam splitter 12 between collimator 13 and objective lens 16 (objective light-converging means, lens structure portion), and a beam that is made to be in parallel substantially by the collimator 13 passes through the beam splitter 12 to advance toward the objective lens 16. Then, a light flux reflected on information recording surface 22 of HD-DVD 20 having protective base board 21 is made by the beam splitter 12 serving as an optical path changing means to advance toward photodetector 30.

The objective lens 16 has, on its outer circumference, flange portion 16a by which the objective lens 16 can be mounted on the optical pickup device 1 easily. Further, the flange portion 16a has a plane that is mostly perpendicular to optical axis La of the objective lens 16, and this plane can enhance a precision for mounting of the objective lens 16 easily.

When recording or reproducing information for HD-DVD 20, light flux L emitted from semiconductor laser light source 11 passes through collimator 13 to become a parallel light flux, then, is stopped down by diaphragm 14 through beam splitter 12, and is converged by the objective lens 16 on focus Lb on information recording surface 22 through protective base board 21 of HD-DVD 20. With regard to intensity of light flux L emitted from semiconductor laser light source 11, the intensity for recording of information is established to be higher than that for reproducing of information.

When reproducing information recorded on HD-DVD 20, a light flux emitted from the objective lens 16 stated above is further modulated by information bits on information recording surface 22 to be reflected, and its reflected light passes through objective lens 16 again and through diaphragm 14 in succession, and is reflected by beam splitter 12 to be given astigmatism by cylindrical lens 17, and enters photodetector 30 through concave lens 18. The photodetector 30 detects incident light from the concave lens 18 to output signals, and the outputted signals are used to obtain signals for reading information recorded on HD-DVD 20.

Further, changes in an amount of light caused by changes of a form and a position of a spot on the photodetector 30 are detected, and focusing detection and track detection are conducted. Based on results of the detection, two-dimensional actuator 15 moves objective lens 16 so that light flux L emitted from semiconductor laser light source 11 may form an image on information recording surface 22 of HD-DVD 20 as focus Lb, and moves objective lens 16 so that light flux L emitted from semiconductor laser light source 11 may form an image on a prescribed track on information recording surface 22.

As shown in FIG. 2, the objective lens 16 is a single lens whose both sides are aspheric, and it has therein an incident surface 161 where light flux L emitted from semiconductor laser light source 11 enters and emergent surface 162 from which the light flux L that has entered the incident surface 161 emerges to focus Lb of information recording surface 22 through protective base board 21 of HD-DVD 20. An optical functional surface of the incident surface 161 is an optical functional area in a shape of concentric circles on optical axis La representing the center, and there is formed serrated diffractive ring-shaped structure portion β composed of ring-shaped zones G1-Gn (wherein, n represents the number of ring-shaped zones, and each number of the ring-shaped zone grows greater as it moves outward from center La) in a shape of concentric circles. Further, on the objective lens 16, there is formed base aspheric surface H (dotted lines in FIG. 2) expressed by the following expression of an aspheric surface form (Numeral 1).

$$X = \frac{( {h}^{2} / R )}{1 + \sqrt{1 - ( 1 + κ ) {( h / R )}^{2}}} + {\sum }_{i = 0}^{9} {A}_{2 i} {h}^{2 i} \qquad ( Numeral 1 )$$

In the expression above, X represents a value (the advancing direction of light flux L entering objective lens 16 is positive) of an axis in the direction of optical axis La, h represents a value (height from the optical axis La) of an axis in the direction perpendicular to the optical axis La, R represents paraxial radius of curvature, κ represents the constant of the cone and A₂ᵢ represents an aspheric surface coefficient.

Further, a pitch of diffractive ring-shaped zones is defined by using optical path difference function Φ. To be concrete, the optical path difference function Φ is expressed by (Numeral 2) with a unit of mm.

$$Φ ( h ) = {\sum }_{i = 0}^{5} {B}_{2 i} {h}^{2 i} \qquad ( Numeral 2 )$$

B₂ᵢ is a coefficient of an optical path difference function. Number of ring-shaped zones n on incident surface 161 is obtained with Φ/λ by using optical path difference function Φ. In this case, λ is a wavelength of a light flux emitted from a laser light source, and diffraction order K is an order of diffracted light obtaining the greatest diffraction efficiency among diffracted light of various orders diffracted by the diffractive ring-shaped structure portion. The diffraction efficiency is a rate of an amount of emergent light of diffracted light in prescribed order to that of diffracted light in all orders diffracted by the diffractive ring-shaped structure portion. Further, with respect to the order of the diffracted light, that in the direction for the diffracted light to advance toward optical axis La is assumed to be positive.

Lens data of the objective lens 16 are shown in the following Table 1.

TABLE 1

| Surface No. | R | d | n |
|---|---|---|---|
| 0 Object point | | ∞ | |
| 1 | Shown in | 1.500 | 1.5246 |
| (aspheric surface, | Table 2 | | |
| diffracting | (I) | | |
| surface) | | | |
| 2 | Shown in | 1.173 | |
| (aspheric surface) | Table 2 | | |
| | (II) | | |
| 3 | ∞ | 0.60 | 1.6187 |
| (cover glass) | | | |
| 4 | ∞ | | |

f = 2.4 mm
NA0.65

In Table 1, d mm is a distance on optical axis La and n is refractive index. With regard to Surface No., 0 is an object point, 1 is a first surface (incident surface 161) of objective lens 16, 2 is a second surface (emergent surface 162) of objective lens 16, 3 is protective base board 21 of HD-DVD 20 and 4 is information recording surface 22 of HD-DVD 20. Focal distance f from a principal point of objective lens 16 to focus point Lb on information recording surface 22 along optical axis La in the case when a light flux with standard wavelength for use λ₀ (=405 nm) enters objective lens 16 is assumed to be 2.4 mm. Numerical aperture NA of objective lens 16 on the image side (on the side of HD-DVD 20) is 0.65, and sufficient image forming capacity is ensured for a thickness d3=0.60 mm of protective base board 21 of HD-DVD 20. Further, refractive indexes n for the objective lens 16 and for protective base board 21 are shown.

Following Table 2 shows each value of aspheric surface coefficient A₂ᵢ in the expression of an aspheric surface form in (Numeral 1) above and coefficient B₂ᵢ of an optical path difference function in the optical path difference function of (Numeral 2.

TABLE 2
(I)First surface
Aspheric surface coefficient

| | |
|---|---|
| κ | −0.83899 |
| R | 1.5518 |
| A₀ | 0.0 |
| A₂ | 0.0 |
| A₄ | 0.99748 × 10⁻² |
| A₆ | −0.67103 × 10⁻⁴ |
| A₈ | 0.14401 × 10⁻² |
| A₁₀ | −0.71063 × 10⁻³ |
| A₁₂ | 0.27069 × 10⁻³ |
| A₁₄ | −0.65903 × 10⁻⁴ |

(III)
Coefficient of optical path difference function

| | |
|---|---|
| Standard wavelength for use λ₀ | 405 nm |
| Diffraction order | 3 |
| B₀ | 0.0 |
| B₂ | −3.37934 × 10⁻² |
| B₄ | 0.52430 × 10⁻³ |
| B₆ | −0.22084 × 10⁻³ |
| B₈ | −0.71200 × 10⁻⁴ |
| B₁₀ | 0.17193 × 10⁻⁴ |

Second surface
Aspheric surface coefficient

| | |
|---|---|
| κ | −50.0000 |
| R | −6.2256 |
| A₀ | 0.0 |
| A₂ | 0.0 |
| A₄ | 0.93157 × 10⁻² |
| A₆ | 0.48983 × 10⁻² |
| A₈ | −0.60555 × 10⁻² |
| A₁₀ | 0.19105 × 10⁻² |
| A₁₂ | −0.25287 × 10⁻³ |
| A₁₄ | 0.58014 × 10⁻⁵ |

Table 2 (I) shows paraxial radius of curvature R in base aspheric surface H of the first surface (incident surface 161), constant of the cone κ and aspheric surface coefficient A₂ᵢ, Table 2 (II) shows paraxial radius of curvature R in base aspheric surface of the second surface (emergent surface 162), constant of the cone κ and aspheric surface coefficient A₂ᵢ and Table 2 (III) shows coefficient B₂ᵢ of the optical path difference function in diffractive ring-shaped structure portion β of the first surface (incident surface 161).

A diffraction order of diffracted light showing the greatest diffraction efficiency among all diffracted light is represented by K as in the foregoing. Respective data shown in Table 2 are data of objective lens 16 in one example in the present embodiment. In particular, Table 2 (III) shows diffractive ring-shaped structure portion β wherein diffraction order K is 3 and standard wavelength for use λ₀ of light flux L emitted from semiconductor laser light source 11 is 405 nm. Therefore, number of ring-shaped zones n can be obtained by an expression of Φ/λ₀, and a pitch of the diffractive ring-shaped structure portion β is also obtained from the number of ring-shaped zones n. Further, an amount of displacement between adjoining ring-shaped zones in the direction of optical axis La is established so that blazed wavelength may agree with the standard wavelength for use λ₀. Incidentally, the blazed wavelength is a wavelength which makes the diffraction efficiency to be greatest in the diffracted light in diffraction order K.

Plastics such as olefin type resins, for example, are used as a material of objective lens 16, and for a material of protective base board 21 of optical information recording medium 20, polycarbonate resins (PC), for example, are used as a cover glass.

In objective lens 16 shown in Table 2, a pitch of the diffractive ring-shaped structure portion β can be made to be greater than that in the occasion where diffraction order K is 1 or 2 because the diffraction order K is 3, the number of ring-shaped zones is reduced, the number of dullness cases in the diffractive ring-shaped structure portion β becomes less, diffracting power of diffracted light in third order is raised and its diffraction efficiency grows greater. Theoretically, a size of the pitch is proportional to diffraction order K. If the diffraction order K is further made to be a large integer, the number of dullness cases in the diffractive ring-shaped structure portion β becomes less in accordance with a value of the diffraction order K, and its diffraction efficiency grows greater.

However, when deviation from standard wavelength for use λ₀ is caused on actual wavelength for use λ of light flux L emitted from laser light source 11, there is generated a phenomenon that the greater the diffraction order K is, and the greater a size of the deviation of the wavelength for use λ from the standard wavelength for use λ is, the more its diffraction efficiency is lowered.

Now, referring to FIG. 3, there will be explained a range for taking satisfactory values for diffraction order K even when deviation of wavelength for use λ from the standard wavelength for use λ₀ is caused. FIG. 3 shows diffraction efficiencies for a plurality of objective lenses whose diffraction orders K range from 1 to 14. Data in Table 1 and in (I) and (II) of Table 2 for each of the plural lenses are the same as those of other lenses, and in particular, an objective lens in the case of diffraction order K=3 has diffractive ring-shaped structure portion β in data shown in Table 2 (III).

Further, “A” in FIG. 3 shows diffraction efficiency in the case where the deviation |λ-λ₀| of wavelength for use λ from the standard wavelength for use λ₀ is 3 nm, “B” shows diffraction efficiency in the case of |λ-λ₀=5 nm, “C” shows diffraction efficiency in the case where a size of dullness in the vertical direction to optical axis La is 1 nm in an edge portion of each ring-shaped zone of diffractive ring-shaped structure portion β, “D” shows a value of A*C representing diffraction efficiency wherein influences of deviation |λ-λ₀|=3 nm for wavelength for use λ in A and dullness of 1 μm in C are taken into consideration, and “E” shows a value of B*C representing diffraction efficiency wherein influences of deviation |λ-λ₀|=5 nm for wavelength for use λ in B and dullness of 1 μm in C are taken into consideration. Incidentally, an influence of dullness in a size of 1 μm on diffraction efficiency is not merely a value shown by an area ratio of a dullness portion to an area of incident surface 161.

FIG. 3 shows that diffraction order K showing a value of 95% or more which is a good value for diffraction efficiency is in a range of about 3≦K≦14 (K is an integer), when diffraction efficiency is influenced by deviation |λ-λ₀|=3 nm for wavelength for use λ in A and dullness of 1 μm in C, as shown by “D”. In the same way, it is understood that diffraction order K showing a value of 96% or more which is a good value for diffraction efficiency is in a range of about 4≦K≦11 (K is an integer) in “D”.

Further, as shown in “E”, it is understood that diffraction efficiency K showing a value of 95% or more which is a good value for diffraction efficiency is in a range of about 3≦K≦7 (K is an integer), when diffraction efficiency is influenced by |λ-λ₀|=5 nm for wavelength for use λ in B and dullness of 1 μm in C.

Now, referring to FIG. 4, correction of paraxial chromatic aberration of objective lens 16 and correction of mode hop caused partially by the correction of paraxial chromatic aberration will be explained. FIG. 4 shows vertical spherical aberrations SA mm respectively for wavelengths for use λ respectively for standard wavelengths for use λ₀ of 405 nm, 400 nm and 410 nm and image-side numerical apertures NA. This objective lens 16 is a lens using various data shown in Table 1 and Table 2.

The paraxial chromatic aberration is represented by a value of vertical spherical aberration SA in image-side numerical aperture NA=0. Paraxial chromatic aberration of an objective lens having no diffractive ring-shaped structure portion β in the case of wavelength for use λ of 405±5 nm takes a value that is about twice that in objective lens 16 in the case of standard wavelength for use λ of 405±5 nm in FIG. 4, which is not illustrated in FIG. 4. Therefore, paraxial chromatic aberration of the objective lens 16 turns out to be about a half of paraxial chromatic aberration in the case of no diffractive ring-shaped structure portion β provided, which proves that the objective lens 16 has a function to correct paraxial chromatic aberration.

In FIG. 4, a graph showing that deviation of wavelength for use λ from standard wavelength for use λ₀ is ±5 nm intersects with an axis of vertical spherical aberration SA=0 respectively, which clearly proves that the objective lens 16 has a function to correct focus shifting caused by mode hop. In FIG. 4, on the graph wherein no mode hop is corrected, vertical spherical aberration SA is also increased upward to the right as numerical aperture NA is increased in the case of wavelength for use λ=400 nm, and vertical spherical aberration SA is also increased upward to the left as numerical aperture NA is increased in the case of wavelength for use λ=410 nm, and neither of them intersects with an axis of vertical spherical aberration SA=0.

Therefore, the objective lens 16 has a function to correct paraxial chromatic aberration when deviation of wavelength for use λ from standard wavelength for use λ₀ is ±5 nm or less, and it further has a function to correct shifting of focus Lb caused by mode hop after correction of the paraxial chromatic aberration.

Thus, in the present embodiment, owing to the structure wherein diffraction order K for the diffractive ring-shaped structure portion β of the objective lens 16 is made to be within a range of 3≦K≦14, it is possible to make diffraction efficiency of K order diffracted light to be 95% or more to make a light flux with a sufficient amount of light to be converged on information recording surface 22 of HD=DVD 20, and to conduct either one of or both of reproducing and recording of information, while the objective lens 16 has a function to correct focus shifting caused by mode hop, even when dullness in size of 1 μm is formed on diffractive ring-shaped structure portion β and deviation of wavelength for use λ from short standard wavelength for use λ₀ represented by |λ-λ₀|≦3 nm is caused. Since an amount of light of a light flux converged on information recording surface 22 of HD-DVD 20 at high diffraction efficiency is enhanced, it is possible to increase speed of reproducing and recording of information for information recording surface 22, and to weaken the power of a light flux emitted from semiconductor laser light source 11.

In the same way, owing to the structure wherein diffraction order K for the diffractive ring-shaped structure portion β of the objective lens 16 is made to be within a range of 4≦K≦11, it is possible to make diffraction efficiency of K order diffracted light to be 96% or more to make a light flux with a sufficient amount of light to be converged on information recording surface 22 of HD=DVD 20, and to conduct either one of or both of reproducing and recording of information, while the objective lens 16 has a function to correct focus shifting caused by mode hop, even when dullness in size of 1 μm is formed on diffractive ring-shaped structure portion β and deviation of wavelength for use λ represented by |λ-λ₀|≦3 nm is caused.

Further, owing to the structure wherein diffraction order K for the diffractive ring-shaped structure portion β of the objective lens 16 is made to be within a range of 3≦K≦7, it is possible to make diffraction efficiency of K order diffracted light to be 95% or more to make a light flux with a sufficient amount of light to be converged on information recording surface 22 of HD=DVD 20, and to conduct either one of or both of reproducing and recording of information, while the objective lens 16 has a function to correct focus shifting caused by mode hop, even when dullness in size of 1 μm is formed on diffractive ring-shaped structure portion β and deviation of wavelength for use represented by |λ-λ₀|≦5 nm is caused.

It is further possible to make molding of objective lens 16 to be easy and to realize low cost and light weight, because a material of the objective lens 16 is made to be plastic.

Incidentally, in the present embodiment, a light flux having standard wavelength for use λ₀=405 nm is emitted from a laser light source to enter objective lens 16. However, the invention is not limited to this and can be equally applied to the occasion wherein standard wavelength for use λ₀ is established to be within a range of 380 nm≦λ₀≦450 nm.

Further, in the present embodiment, image-side numerical aperture NA of the objective lens 16 is made to be 0.65. However, the invention is not limited to this and can be equally applied to the occasion wherein the image-side numerical aperture NA, for example, is established to be within a range of 0.60≦NA≦0.90. In this case, it is possible to prevent a decline of recording density of an optical information recording medium caused by small numerical aperture NA and to prevent that large numerical aperture NA makes manufacture of objective lens to be difficult. With regard to this, when the image-side numerical aperture NA is made to be in 0.6≦NA≦0.70, it is possible to further prevent that large numerical aperture NA makes manufacture of objective lens to be difficult.

Further, in the present embodiment, focal length f from objective lens 16 to information recording surface 22 of HD-DVD 20 along optical axis La is made to be 2.4 mm. However, the invention is not limited to this and can be equally applied to the occasion wherein focal length f, for example, is established to be within a range of 1.8 mm≦f≦3.0 mm. In this case, it is possible to prevent a decline of a working distance caused by small focal length f and to prevent an increase of a size of an optical pickup device equipped with an objective lens caused by a large focal length f. The working distance is a distance from emergent surface 162 or flange portion 16a of objective lens 16, for example, to information recording surface 22 of HD-DVD 20. When the working distance is small, possibility for the objective lens 16 to be scratched or contaminated is raised because the objective lens-16 turns out to be touched easily from the outside.

Further, the present embodiment employs the structure wherein diffractive ring-shaped structure portion β is provided only on incident surface 161 of objective lens 16. However, the invention is not limited to this, and the structure for providing only on emergent surface 162 and the structure for providing on both incident surface 161 and emergent surface 162 may also be employed. Further, in the present embodiment, objective lens 16 is a single lens. However, the invention is not limited to this, and it is also possible to arrange so that various structures may be employed by changing the objective lens to an objective light-converging means composed of plural optical elements. When it is composed of plural optical elements, in particular, a lens structure portion that refracts a light flux emitted from a laser light source and a diffractive ring-shaped structure portion may also be formed separately. In the present embodiment, objective lens 16 representing a single lens has both the lens structure portion and the diffractive ring-shaped structure portion. Further, in the present embodiment, the diffractive ring-shaped structure portion β is indented. However, the invention is not limited to this, and those in a stepped shape may be employed.

Though the embodiments of the invention have been explained above, the invention is not always limited to the aforementioned means and methods, and they may be modified appropriately within a range in which the object of the invention is attained and effects of the invention are exhibited.

(Effect of the invention)

In the invention described in Structure (1), owing to the structure wherein diffraction order K for the maximum diffraction efficiency in the diffractive structure portion is made to be within a range of 3≦K≦14, it is possible for the objective light-converging means to enhance diffraction efficiency of K order diffracted light and to converge a light flux having a sufficient amount of light on an information recording surface of an optical information recording medium, while having functions to correct paraxial chromatic aberration and to correct focus shifting caused by mode hop, even when dullness is formed on a diffractive structure portion and deviation of wavelength for use λ from short standard wavelength λ₀ is caused.

In the invention described in Structure (2), it is possible to realize easy molding, low cost and light weight of an objective light-converging means, because materials of a lens structure portion and a diffractive structure portion are made to be plastic.

In the invention described in Structure (3), it is possible to take various structures, because each of a lens structure portion and a diffraction structure portion is composed of a single lens or a plurality of optical elements. In particular, when a plurality of optical elements are used, it is also possible to take the structure wherein each optical element is provided with a diffractive structure portion.

In the invention described in Structure (4), it is possible to prevent a decline of recording density of the optical information recording medium caused by the small numerical aperture NA and to prevent that manufacture of the objective light-converging means is difficult because numerical aperture NA is great, because numerical aperture NA of the objective light-converging means on the side of the optical information recording medium satisfies 0.60≦NA≦0.90.

In the invention described in Structure (5), it is possible to prevent a decline of recording density of the optical information recording medium caused by the small numerical aperture NA and to prevent further that manufacture of the objective light-converging means is difficult because numerical aperture NA is great, because numerical aperture NA of the objective light-converging means on the side of the optical information recording medium satisfies 0.60≦NA≦0.70.

In the invention described in Structure (6), focal distance f from a principal point of the objective light-converging means to a focal point on the optical information recording medium satisfies 1.8 mm≦f≦3.0 mm, and therefore, it is possible to prevent that a working distance is reduced by small focal distance f, and the objective light-converging means is damaged and contaminated accordingly, and it is possible to prevent that a size of an optical pickup device equipped with the objective light-converging means is made to be large because focal distance f is large.

It is possible to enhance the diffraction efficiency of K-order diffracted light and to converge a light flux with a sufficient amount of light on an information recording surface of an optical information recording medium so that either one of reproducing and recording of information or both of them may be conducted, while keeping the function to correct focus shift caused by mode hop, even when dullness is formed on a diffractive structure portion and deviation of actually used wavelength λ from short standard wavelength λ₀ is caused, because an objective light-converging means in either one of Structures 1-6 is used to converge light on an information recording surface of an optical information recording medium. It is further possible to increase the speed of either one or both of reproducing and recording of information for an information recording surface because an amount of light of a light flux to be converged on the information recording surface of the optical information recording medium is enhanced with high diffraction efficiency, and it is possible to reduce the power of the light flux emitted from the light source.

What is claimed is:

1. An objective light converging element for use in an optical pickup device and used to converge a light flux having a reference wavelength λ₀ (380 nm≦λ₀≦450 nm) emitted from a light source onto an information recording plane of an optical information recording medium equipped with a protective substrate having a thickness of 0.6 mm, comprising:
a lens structural section to refract a light flux emitted from the light source; and
a ring-shaped diffractive structural section having an optical axis on a center and to diffract a light flux emitted from the light source;
wherein an order K of a diffracted-light ray having the maximum diffraction efficiency among diffracted-light rays of the light flux generated by the diffractive structural section satisfies the following formula:
3≦K≦14 (provided that K is an integer)

2. The objective light converging element of claim 1, wherein the order K satisfies the following formula:
3≦K≦7

3. The objective light converging element of claim 1, wherein the order K satisfies the following formula:
4≦K≦11

4. The objective light converging element of claim 1, wherein the lens structural section and the diffractive structural section are made of a plastic material.

5. The objective light converging element of claim 1, wherein the lens structural section and the diffractive structural section is constructed by a single lens or by plural optical elements.

6. The objective light converging element of claim 1, wherein an optical information recording medium-side numerical aperture NA of the objective light converging element satisfies the following formula:
0.60≦NA≦0.90

7. The objective light converging element of claim 6, wherein an optical information recording medium-side numerical aperture NA of the objective light converging element satisfies the following formula:
0.60≦NA≦0.70

8. The objective light converging element of claim 6, wherein a focal length from a principal point to a focal point on the optical information recording medium satisfies the following formula:
1.8 mm≦f≦3.0 mm

9. An optical pickup apparatus, comprising:
a light source to emit a light flux;
an objective light converging element to converge the light flux onto an information recording plane of an optical information recording medium so that the optical pickup apparatus conduct reproducing and/or recording information for the optical information recording medium.
